(19) United States
(12) Patent Application Publication
(10) Pub. No.: US 2022/0018568 A1
(43) Pub. Date: Jan. 20, 2022

(54) HVAC FORCED AIR AUGMENTING APPARATUS AND METHOD

(71) Applicant: ELBYTE INC., Mississauga (CA)

(72) Inventor: Krzysztof Gosciniak, Mississauga (CA)

(21) Appl. No.: 16/929,726

(22) Filed: Jul. 15, 2020

(51) Int. Cl. F24F 11/77; F24F 11/56; F24F 13/20; F24F 13/08; F24F 11/00; F24F 11/89; F24F 13/02

(52) U.S. Cl. CPC F24F 11/77; F24F 11/56; F24F 13/20; F24F 13/082; F24F 2130/40; F24F 11/89; F24F 13/02; F24F 2013/205; F24F 11/0001

(57) ABSTRACT

Apparatus for increasing a flow of forced air from a HVAC unit having a blower fan into a heating/cooling zone has a register unit for passing forced air from a duct connected between the HVAC unit and the register unit. A fan at the register unit operates to increase the forced air flow rate through the register. A control signal is emitted from a wireless transmitter in response to remotely detected operation of the HVAC blower fan. The control signal is transmitted over a radio link between the HVAC unit and a receiver at the register unit and is used to control operation of the register fan.

### CROSS REFERENCE TO RELATED PATENTS

### Field of the Invention

This invention relates to forced air heating, ventilation and/or cooling (HVAC) systems and has particular but not exclusive application to retrofitting apparatus for installed HVAC systems to augment forced air flow to individual heating/cooling registers.

### BACKGROUND

Forced-air systems typically have a central HVAC unit, being a furnace, an air conditioner (cooler) and/or a combined unit for heating/cooling a flow of air which is forced by a blower fan through the central HVAC unit. Ducts connecting the central HVAC unit to the zones to be heated/cooled enable transfer of the forced air from the central HVAC unit out to the zones, typically rooms. In each of the rooms, usually at floor level, is mounted one or more registers at which forced air exits a duct and enters the room to provide heating/cooling of the room and its contents.

The cross-sectional bore and the length of a duct connecting the central HVAC unit to a heating/cooling zone can have a significant effect on system efficiency. If the ducts or HVAC unit are not optimally sized, there may not be the required amount of airflow to one or more of the rooms to have a desired heating/cooling effect at those rooms. Insufficient forced air flow may also cause long term damage to the central HVAC unit.

The condition of a duct can also affect air flow and therefore system efficiency. Small leaks from the duct can reduce airflow to a room that is served by that duct. Large leaks, such as from loose joints, can substantially eliminate airflow through the duct especially where the room is a long way from the central HVAC unit. Further loss of heating/cooling can occur at the room owing to poor wall, floor or ceiling insulation or owing to thin walls, this being generally more prevalent in older homes. As well as resulting in an insufficiently heated/cooled room, there is an associated waste of energy and a corresponding cost as the HVAC unit must run longer to effect a desired level of heating/cooling of a room or of the whole house.

One characteristic of central heating/cooling is that heat rises. For example, in a typical two-story home, there is an 8 to 10° C. temperature difference between the upstairs and the downstairs levels. In most home heating/cooling systems, the temperature is monitored only at a single central thermostat. Such a thermostat is only fully effective in regulating the temperature of the room in which it is installed. When that room reaches a pre-set temperature, the HVAC system shuts off to prevent the room from becoming too hot or too cold. At that time, rooms that are laterally or vertically spaced from the thermostat may be left in an under-conditioned state insofar as these rooms will not have been brought to that pre-set temperature. Another effect of a central HVAC system is that hot air cools as it is blown further along the duct system from the HVAC unit. Similarly, cold air warms in the course of its transit. This is compounded by the blown air tending to lose delivery pressure further along the duct system in comparison with the air pressure as it is first launched from the heating/cooling plenum. Both effects mean that rooms that are located further away from the HVAC unit or at the ends of the ductwork may not be heated/cooled as well as other rooms.

The problem of uneven room heating has been addressed in a number of different ways. In one method, in-line boosting of air flow is effected using fans mounted inside ducts. This solution is only really applicable to newly built houses because a retrofit requires removing floor boards, opening up ducts to enable installation of booster fans, and installing electrical supply wiring and other elements. For the same reason, faulty fans in installed systems are difficult to repair. Outside boosters are known that can be installed over the top of registers but these are generally manually switched and so require the presence of a person in the room where the booster fan is installed to switch it on. In zoned systems, the temperatures of rooms or other zones are individually controlled so that, for example, bedrooms are not heated/cooled during the day because they are normally empty at that time. Such systems need a smart thermostat and corresponding intelligence at room vents and/or in-line boosters and, as such, are generally not suitable for retrofitting because of the cost and inconvenience of installation.

The present invention is applicable to both heating and cooling systems and to combined systems. In this specification, when referring to forced air as being conditioned, it will be understood that the term may mean either heated or cooled.

### SUMMARY OF THE INVENTION

According to one aspect of the invention, there is provided apparatus for use in increasing a flow of conditioned air from a HVAC unit, the HVAC unit having a blower fan for forcing heated or cooled air from the HVAC unit through a duct to a zone to be heated or cooled, the apparatus comprising a register unit having a register for passing the forced air from the duct into the zone and a register fan operable to increase a flow rate of the forced air through the register, a detector at the HVAC unit for detecting when the blower fan is operating, a radio link having a transmitter at the HVAC unit for generating a first control signal in response to the detection of the blower fan operating, and a receiver unit at the register unit for receiving the first control signal and, in response thereto, generating a second control signal for powering the register fan.

According to another aspect of the invention, there is provided a method of increasing a flow of forced air from a HVAC unit having a heater and/or cooler sub-unit and a blower sub-unit having a blower fan for forcing heated or cooled air through a duct system to a heating/cooling zone, the method comprising at a register unit having a register for passing the forced air from a duct connected between the HVAC unit and the register unit, detecting at the HVAC unit when one of the HVAC sub-units is operating, generating a first control signal in response to the detection of operation of said one of the HVAC sub-units, wirelessly sending the first control signal to a receiver unit at the register unit and, in response to receiving the first control signal, generating a second control signal for powering a register fan at the register unit to increase a flow rate of the forced air through the register unit.

### BRIEF DESCRIPTION OF THE DRAWING

For simplicity and clarity of illustration, elements illustrated in the accompanying figure are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a schematic view of a known HVAC combined heating and cooling unit.

FIG. 2 shows an embodiment of apparatus according to the invention for use with installed HVAC systems to augment forced air flow to individual heating/cooling registers.

FIG. 3 shows signal processing sequence for use in the apparatus of FIG. 2.

FIG. 4 shows an alternative embodiment of sensor and transmitter apparatus according to an embodiment of the invention.

FIG. 5 is an isometric view from above of a cover plate for a register unit forming part of apparatus according to an embodiment of the invention.

FIG. 6 is an isometric view from above of a casing forming part of apparatus according to an embodiment of the invention.

FIG. 7 is an isometric view from above of an insert forming part of apparatus according to an embodiment of the invention.

FIG. 7A is an isometric view from above of the insert of FIG. 7 but showing booster fans mounted thereto.

FIG. 8 shows an alternative embodiment of apparatus according to the invention for use with installed HVAC systems to augment forced air flow to individual heating/cooling registers.

FIG. 9 shows a further alternative embodiment of apparatus according to the invention for use with installed HVAC systems to augment forced air flow to individual heating/cooling registers.

FIG. 10 shows yet another alternative embodiment of apparatus according to the invention for use with installed HVAC systems to augment forced air flow to individual heating/cooling registers.

FIG. 11 shows a variation of the apparatus of FIG. 10.

FIG. 12 is a sectional view from one side of a register unit forming part of apparatus according to an embodiment of the invention, the register unit installed in a floor opening.

FIG. 13 is a sectional view from one side of a register unit forming part of apparatus according to an embodiment of the invention, the figure illustrating an air amplifier arrangement.

### DETAILED DESCRIPTION OF THE INVENTION INCLUDING THE PRESENTLY PREFERRED EMBODIMENTS

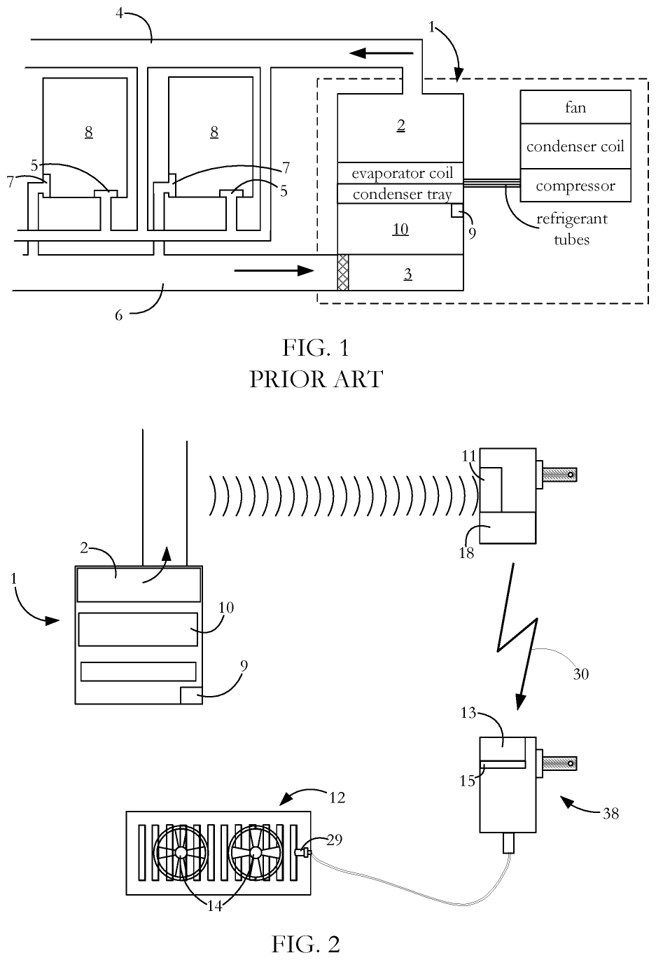

Referring to FIG. 1, there is schematically illustrated a known form of HVAC system. The system has a central HVAC unit 1 such as a furnace, air conditioner (air cooler), or as in the illustrated case, a combination of the two. The HVAC unit 1 is typically located at a relatively central location in a home or other building that is to be heated/cooled. When the HVAC unit 1 is operating, air in a plenum 2 is heated or cooled and a blower fan 3 blows the heated/cooled air along a delivery duct system 4 from the plenum 2 to output registers 5. The registers 5 are typically mounted in openings in the floors of rooms or other zones that are to be heated/cooled. A corresponding air return duct system 6 coupled between return registers 7 and the HVAC unit 1 transfers air from the heated or cooled rooms 8 back to the HVAC plenum 2 where it is subject to further heating/cooling to restore its room heating/cooling capacity. In a passive system, duct sizes are selected so as, to the extent possible, to keep temperatures of different rooms roughly even regardless of the size of room or its distance from the central HVAC unit.

In operation, when in heating-ready mode, a thermostat (not shown) mounted somewhere in the house and hardwired or wirelessly connected to a HVAC unit controller 9 sends a signal to the controller 9 when the temperature at the thermostat drops below a pre-set level. In response, the furnace burner 10 is switched on and air in the plenum 2 is heated. A short time after the burner 10 is turned on, when air in the plenum 2 reaches a pre-set temperature required for heating of the house to begin, the blower fan 3 is turned on to force air out of the plenum 2 and into the delivery duct system 4. Cool air is drawn through the return duct system 6 and from outside into the plenum 2 to set up a cycle of heated blown air. In a cooling-ready mode, the thermostat sends a signal to the air conditioner controller when the temperature at the thermostat rises above a pre-set level. In response, air in the plenum 2 is brought to a pre-set temperature required for cooling to begin and the blower fan 3 is turned on to force air out of the plenum 2 and into the delivery duct system 4. Warm air from the rooms is drawn back through the return duct system 6 into the plenum 2 to set up a cycle of cooled blown air.

In one aspect of the present invention, as shown in FIG. 2, a sensor 11 is mounted at a wall unit 39 that plugs into a mains outlet and operates to detect operation of the blower fan 3. The sensor 11 is connected to a radio transmitter 18 which emits a continuous signal while the HVAC blower fan 3 is operating. The HVAC transmitter 18 is wirelessly linked to a radio receiver 13 at a wall unit 38 that plugs into a mains outlet and is electrically connected to a corresponding register unit 12. The register unit 12 houses booster fans 14. When the register unit 12 is powered on, its receiver polls the HVAC transmitter output periodically—in one implementation, every 2 seconds—to check whether or not the HVAC blower fan 3 is operating. A controller 15 at the register unit 12 activates its booster fans 14 synchronously with the register unit 12 upon detecting operation of the HVAC blower fan 3. The register unit controller 15 deactivates the booster fans 14 when the blower fan 3 stops running. Operation of the register unit booster fans 14 increases the flow rate of forced heating/cooling air through the register unit 12 in comparison with a corresponding register without a booster fan. Periodic polling is adopted so that if for some reason a message (packet) is lost within the 2 second polling period, the register unit status is quickly updated. Because every register unit polls independently, the HVAC detector can work with multiple active register units without the need to maintain a list of the units. The combination of HVAC detector and register unit works as a small network so that notwithstanding a relatively long range wireless link, interference between neighboring systems is easily avoided. For convenience, a delivery duct system and return duct system to and from the HVAC unit 1 and the register unit 12 are not illustrated in the figures.

In the embodiment illustrated in FIG. 2, the sensor 11 is a microphone configured and positioned to detect the sound of the HVAC blower fan 3 when operating. One exemplary sound sensor is the POM-3535L-2-R electret microphone available from PUI Audio Inc. Another exemplary sound sensor is a silicon MEMS microphone available from Knowles Inc. under product designation SPU0410LR5H-QB-7. Each of these microphones allows remote detection of vibration generated by the HVAC blower fan 3, typically around a frequency of 100 Hz. As shown in the flow diagram of FIG. 3, processing routines in firmware 19 connected to the sensor subject the microphone output to a FFT (fast Fourier transform) and to spectral analysis in the frequency and time domains including building histograms and adaptive maximum signal detection. Analysis of the microphone output is alternatively performed by firmware embodying a machine learning or AI algorithm. Such processing of the microphone output enables background noise such as music, talking, barking, etc., to be filtered from the detected sound caused by the blower fan operation. Microphone sensors 11 are generally easy to install and highly robust and offer the benefit that they can be sited remotely without the need for a wiring connection between the sensor 11 and the HVAC unit 1.

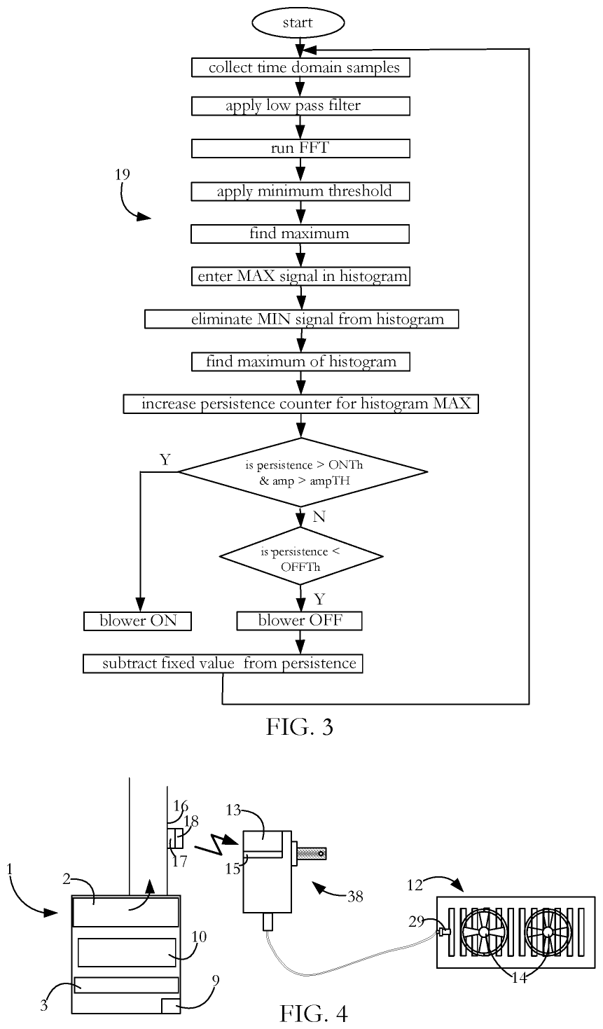

Referring to FIG. 4, in an alternative embodiment of the invention, vibration of a duct panel 16 adjacent the blower fan 3 is detected by a sensor 17 physically mounted at the HVAC unit 1. A corresponding wireless signal is transmitted from transmitter 18 over wireless link 30. The sensor 17 and transmitter 18 are powered by mains electricity from an outlet close to the HVAC unit.

In one specific implementation, a reflective infrared (RIR) transmitter and receiver are mounted side-by-side on the outwardly facing surface of duct panel 16. The RIR transmitter emits a short wavelength IR beam and the RIR receiver detects a corresponding reflected IR beam. When the blower fan 3 is operating, the duct panel 16 vibrates causing dispersal of the incident IR beam and a consequent reduction in the intensity of the reflected IR beam. A suitable RIR motion detector compensated for ambient light is made by Rohm Co. Ltd under product designation RPR-0521RS.

In another implementation, duct panel vibration is detected using a MEMS accelerometer device attached to the panel 16. Typically, such a device adapted for vibration sensing has one or more micro sensors and micro actuators together with associated electronics. A suitable device detecting vibration in three mutually orthogonal axes is made by MEMSIC Inc. under product designation MXR9500G/M

In a further implementation, duct panel vibration is detected using an electro-mechanical accelerometer attached to the panel. An exemplary device is available from Adafruit Industries under product designation 1766 and works on the principle of a vibrating spring which acts as contact switch when activated by the vibrating panel.

In yet another implementation, duct panel vibration is detected using a piezo-electric sensor. Exemplary devices that are attached to the duct panel are available from Seed Studio under the product designation Grove—Piezo Vibration Sensor V.1.1, from Measurement Specialties, Inc. under product designation MiniSense 100, and from PUI Audio Inc. under product designation AB1070B-LW100-R. Piezo-electric sensors can offer particularly high sensitivity and robustness.

Any of a number of possible attachment techniques can be used to attach a vibration sensor 17 to duct panel 16. In one embodiment, an epoxy adhesive is used, with the sensor 17 being temporarily supported during the adhesive curing period. In another embodiment, part of the sensor casing is attached by screws or another mechanical attachment means to the duct panel 16. In a further embodiment, a magnet is mounted with the sensor, although this needs to be very strong otherwise the sensor/magnet combination may slide down and off the duct panel in response to long term panel vibration. Any attached sensor should not be so large or heavy as to materially reduce vibration amplitude at the duct panel attachment location.

It is desirable that the sensor 17 be attached at a position on the duct panel 16 where vibration of the panel is at or near its highest amplitude. In setting up the apparatus, a vibration ‘sweet spot’ can often be tactilely detected. Alternatively and/or in addition, a portable, battery-operated sensor tool having a construction similar to any of the fixed sensors previously discussed and a read-out to show vibration amplitude is pressed lightly against, and slid across, the surface of the duct panel 16.

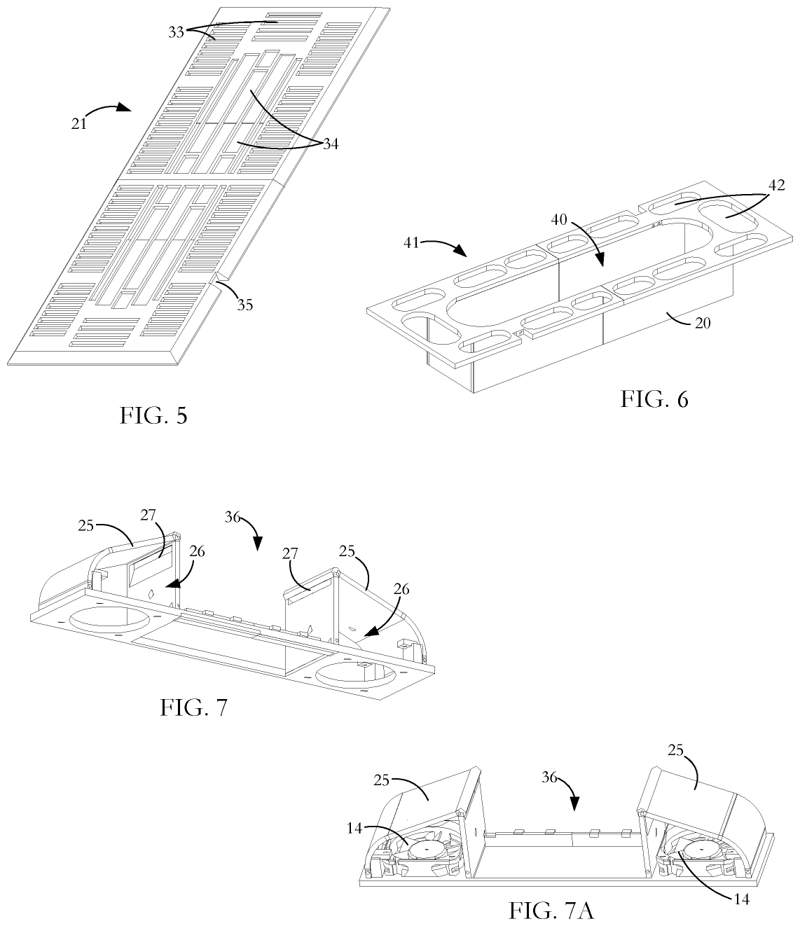

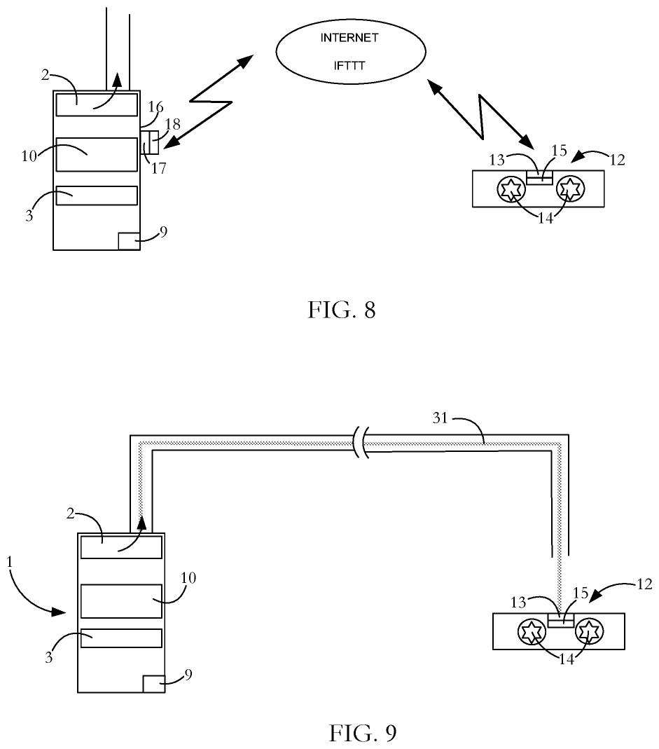

Components of a register unit for use in one embodiment of the invention are illustrated in greater detail in FIGS. 5 through 7A. The register unit has a cover plate 21 (FIG. 5), a casing member 41 (FIG. 6), and an insert piece 36 (FIGS. 7 and 7A).

As shown in FIG. 5, the cover plate 21 marginally larger in length and width than the length and width of a floor opening in which the register unit is installed when in use. The cover plate 21 is in the form of a grid. Around an outer plate region, grid openings 33 extend parallel to the plate width. At a central plate region, larger grid openings 34 extend parallel to the plate length. A small cutout 35 extends into one edge of the cover plate 21 to provide passage for an electrical power lead from a plug-in wall unit 38 to the register unit 12.

As shown in FIG. 6, the rectangular casing member 20 has a plan area sufficiently small that a depending casing 20 can be fitted into a rectangular floor opening to replace a prior mounted register. Standard sized register openings in North America are 4″×10″, 4″×12″, 6″×10″, and 6″×12″. In one embodiment, outer dimensions of the depending casing 20 are 4″×10″ to permit a one size fits all retrofit installation into any of these standard sized floor openings. At the top of the depending casing 20, a peripheral flange extending outwardly from a central housing 40 has apertures 42 for the passage of forced air.

As shown in FIG. 12, for retrofitting the register unit to larger floor openings, space between the edges of a prior-cut floor opening 23 and the depending casing 20 is filled with compressible foam packing 24 to avoid movement of the register unit 12 after installation. For installation in an uncut floor, the floor is simply cut to the 4″×10″ dimension. The cover plate 21 is large enough in area to fully cover any of the mentioned standard area openings together with a marginal support area of the floor immediately bounding the opening.

The depending casing 20 provides a frame to enclose and support the insert piece 36 shown in FIGS. 7 and 7A. The insert piece 36 has two chambers 26 having apertures at which are mounted respective electrically powered booster fans 14 and associated wiring and connections. The insert piece 36 is formed with sloping air amplifier directors 25. Electric motors for driving the fans 14 can be of fixed or adjustable speed. In the latter example, fan speed adjustment capability may be valuable for adapting register units 12 to locations that have different heating/cooling zone volumes and/or that are located at different distances from the HVAC blower motor. A variable speed booster fan 14 may also allow reduction of booster fan noise which can be useful if the fan 14 is, for example, sited in a bedroom and is to be run at night. The use of two fans 14 offers a compromise between small size, high air flow rate, low noise and low cost. Whereas one fan can be used, it would normally connote a relatively large footprint and so may be too large to fit in a standard small register opening. A large fan may also be noisier than an arrangement having two or more smaller fans.

The two fans 14 and their drive motors are mounted in the cylindrical compression chambers 26 for rotation about vertical axes. As shown in FIG. 13, to increase air flow and to render the use of small and quiet fans efficient, the chambers 26 are formed with an air amplifier arrangement. Deflectors 25 direct and channel upwardly flowing forced air towards exit slots 27 in walls of the compression chambers 26. Conditioned air forced into the chambers is put under pressure and the speed of the flowing forced air currents increases as they pass out of the chambers through the slots 27. The expelled currents of conditioned air are directed upwardly and towards each other. The combined flow acts to pull air 28 upwardly from a central part 37 of the vent.

The vent fans 14, receiver 13 and local controller 15 are powered from mains electricity provided at the plug-in wall unit 38. The fans 14 require power of only a few watts and in one embodiment of the invention, power harvesting (using any of ambient existing electromagnetic waves, solar energy, air movement, etc.) is used to supplement or substitute for mains electricity powering of devices 13, 14 and 15.

Referring back to FIG. 2, a preferred wireless link 30 between the HVAC transmitter and the vent fan receiver is by 900 MHz ISM band proprietary radio. Use of the 900 MHz band does not require a license and so permits an independent, proprietary protocol, messaging and communication system. The 900 MHz band is robust through its use of FHSS (Frequency Hopping Spread Spectrum) with frequency constantly changing in a pseudo-random manner. 900 MHz ISM band messages are very short with error correction. In keeping with the plug-and-play aspect of the preferred embodiment, setup and use of a password are not needed because master and slave (HVAC sensor and active vent) are paired during manufacture. The HVAC sensor 11 or 17 can work with multiple register units 12 and, when used in a home environment, is unlikely to suffer interference from other 900 MHz band users. An added benefit is that signals in the 900 MHz ISM band broadcast readily through walls and floors of a multi-floor house. Alternative transmission frequencies such as those for Wi-Fi or Bluetooth can be used within the context of the present invention. However, they require setup (either point to point or network) which complicates installation and so do not easily lend themselves to retrofitting. They also penetrate less well though walls.

Operation of the HVAC blower fan 3 and the vent booster fan 14 can be synchronized in any of several alternative ways.

As shown in FIG. 8, an intelligent thermostat such as EcoBee™, Nest™ or Lyric™ can be programmed to synchronize operation of a register unit booster fan 14 with operation of the HVAC blower fan 3. In home automation, intelligent thermostats use proprietary protocols and there is currently no communication standard between such thermostats and other devices. This makes it difficult to make a retrofit active register unit compatible with different brands of smart thermostat. In such circumstances, because connection to the Internet is available, a service such as IFTTT (If This Then That) can be implemented. IFTTT is a cloud service which connects Internet-enabled devices and allows users to write simple scripts to have devices communicate with each other. Users intending to link an active register unit and an intelligent thermostat can register at the IFTTT website (https://ifttt.com) and be guided through setup. One installation issue however is the requirement for connection setup of an active register unit 12 to the access user's WiFi. To enter SSID and password, a laptop or smartphone application such as Windows, IOS, Android, is necessary and increases complexity of this solution. The arrangement of FIG. 5 also requires uninterrupted access to the Internet if it is to operate optimally.

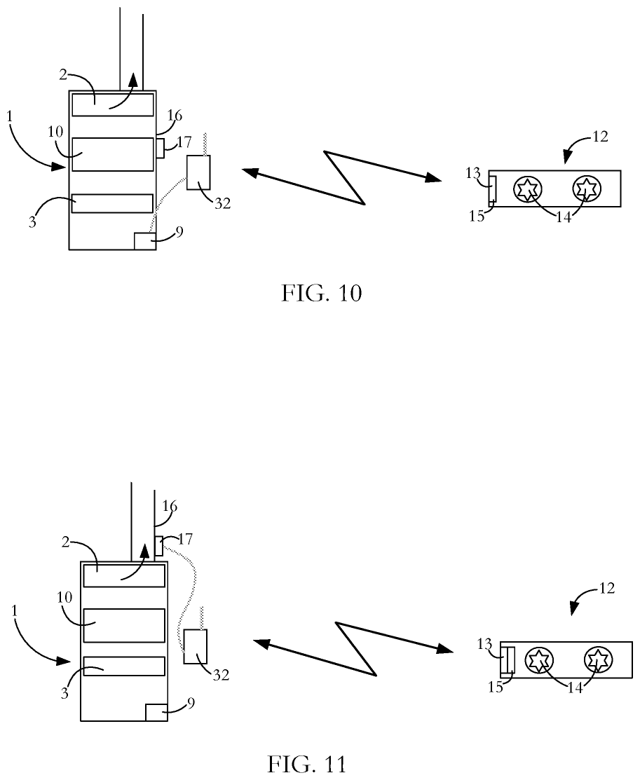

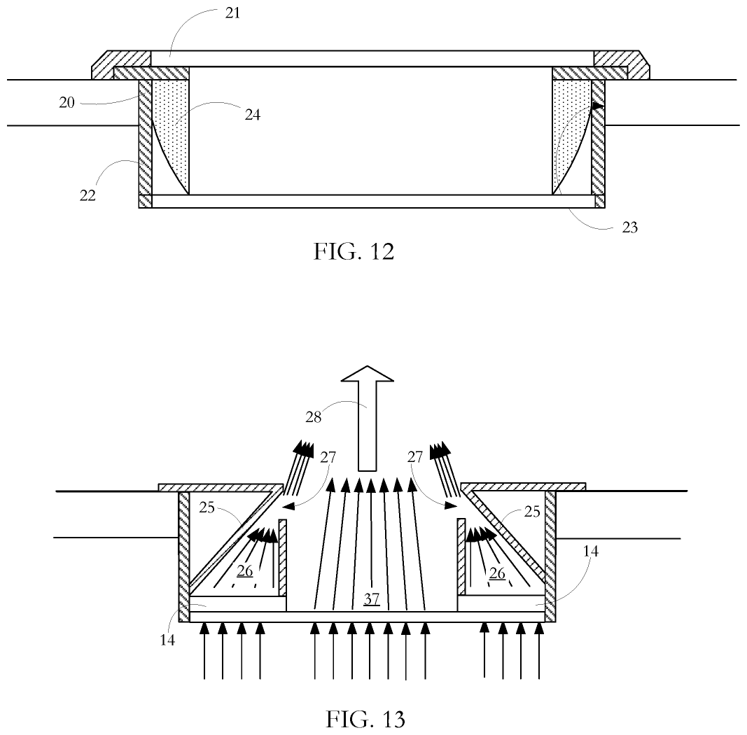

In another alternative as shown in FIG. 9, operation of the active register unit 12 is synchronized with operation of the HVAC blower fan 3 using a cable 31 threaded through the delivery or return duct system 4 or 6 and extending directly between the HVAC unit controller 9 and the register unit controller 15. Installing cable 31 inside a duct system from a furnace room to a room with an air flow problem—usually the most distant from the HVAC unit—is an expensive and laborious task, whether as a new installation or a retrofit. The connection between the HVAC unit and the register unit can alternatively be provided by a dedicated radio link using ISM bands or WiFi nodes. Whereas such a wireless solution is easier, it still has problems compared with the FIG. 2 solution. It requires an electrician to connect the HVAC unit electrical panel to the radio and, for safety reasons, connection to the radio must be galvanically isolated by transformer, optical or other isolating means. A hybrid of the arrangements shown in FIG. 2 and FIG. 9 is shown in FIG. 10. Here, a radio module 33 mounted at or close to the HVAC unit 1 has a wired connection to the HVAC unit controller 9. The radio module 33 alternatively has a wired connection to a vibration sensor as shown in FIG. 11, the vibration sensor configured as previously described.

In a further alternative, an active vent fan switch can be turned on and off manually; for example, if a user in the room where the vent unit is installed receives a sound or other alert indicating that the HVAC fan is operating or has just started or stopped operation, they can switch the vent fan on or off.

Each of the alternative synchronizing solutions described above may be less convenient, and/or more expensive to implement compared with the embodiment of FIG. 2 which has the merit of being truly a plug-and-play solution without the requirement for tools or advanced technical knowledge. The FIG. 2 arrangement and its operation is also independent of the type of thermostat—whether intelligent, zoned, simple bimetallic, etc.—used in the HVAC system.

As an alternative to synchronizing operation of the HVAC blower fan and the register unit fan, operation of an active register fan can be related in a different way to operation of the HVAC unit. For example, switching of a register unit booster fan can be delayed for a certain period of time after blower fan operation is detected. In another alternative, the booster fan can be switched synchronously with or in a timed relation to start-up of the HVAC unit heating/cooling cycle instead of the blower fan cycle.

Referring back to FIG. 2, in a further embodiment of the invention, a UV LED 29 is mounted at the register unit 12 with the UV light beam positioned to intercept air flow as it flows through or exits the register unit 12 with the aim of killing entrained bacteria originating from the duct supplying the register unit 12.

Other variations and modifications will be apparent to those skilled in the art and the embodiments of the invention described and illustrated are not intended to be limiting. The principles of the invention contemplate many alternatives having advantages and properties evident in the exemplary embodiments.

What is claimed is:

1. Apparatus for use in increasing a flow of conditioned air from a HVAC unit, the HVAC unit having a blower fan for forcing heated or cooled air from the HVAC unit through a duct to a zone to be heated or cooled, the apparatus comprising a register unit having a register for passing the forced air from the duct into the zone and a register fan operable to increase a flow rate of the forced air through the register, a detector at the HVAC unit for detecting when the blower fan is operating, a radio link having a transmitter at the HVAC unit for generating a first control signal in response to the detection of the blower fan operating, and a receiver unit at the register unit for receiving the first control signal and, in response thereto, generating a second control signal for powering the register fan.

2. The apparatus of claim 1, wherein the transmitter is operable to generate the first control signal during a first period related to a second period in which operation of the blower fan is detected.

3. The apparatus of claim 2, wherein the first period is the same as the second period.

4. The apparatus of claim 3, wherein the receiver is operable to periodically poll the transmitter output for existence of the first control signal.

5. The apparatus of claim 1, wherein the radio link operates in the 900 MHz band of the UHF radio spectrum.

6. The apparatus as claimed in claim 1, wherein the register fan comprises part of an air amplifier arrangement at the register unit.

7. The apparatus as claimed in claim 6, wherein the register fan is configured to direct a part of the forced air into a compression cavity having an outlet aperture for directing a restricted area forced air stream away from the register to create air amplification at a confluence with other of the forced air passing through the register.

8. The apparatus as claimed in claim 7, wherein the air amplifier arrangement incorporates a plurality of such register fans for directing parts of forced air into respective compression cavities, and output apertures from the compression cavities for directing a plurality of restricted forced air streams towards each other and away from the register to create such air amplification.

9. The apparatus as claimed in claim 1, the register unit having a casing arrangement shaped and dimensioned to house the register fan unit and to be housed in a floor aperture.

10. The apparatus as claimed in claim 9, wherein the casing arrangement has a face plate dimensioned to cover any of a plurality of standard sized floor apertures including 4″×10″, 4″×12″, 6″×10″, and 6″×12″ floor apertures wherein margin parts of the faceplate extend across edges of the floor apertures.

11. The apparatus as claimed in claim 1, wherein the sensor is a microphone.

12. The apparatus as claimed in claim 11, wherein the microphone is mounted remotely from the HVAC unit.

13. The apparatus as claimed in claim 11, further comprising processing firmware for analyzing sound input received by the microphone to detect presence of the first control signal.

14. The apparatus of claim 1, wherein the sensor is attached to a duct panel adjacent to the HVAC unit.

15. The apparatus if claim 14, wherein the sensor incorporates one of a reflective infrared (RIR) vibration detector, an electromagnetic (EM) vibration detector, a micro-electromechanical system vibration (MEMS) detector and a piezoelectric (PE) vibration detector.

16. The apparatus of claim 14, wherein the sensor is attached to the duct panel by one of screw fixtures, adhesive, magnet, panel mounts and soldering.

17. The apparatus if claim 14, wherein the sensor is attached at or close to a region of high vibratory amplitude of the duct panel when the blower fan is operating.

18. The apparatus of claim 1, further including wiring between a mains plug and the register fan unit for enabling mains powering of the register fan unit.

19. (canceled)

20. (canceled)

21. A method of increasing a flow of forced air from a HVAC unit having a heater and/or cooler sub-unit and a blower sub-unit having a blower fan for forcing heated or cooled air through a duct system to a heating/cooling zone, the method comprising at a register unit having a register for passing the forced air from a duct connected between the HVAC unit and the register unit, detecting at the HVAC unit when one of the HVAC sub-units is operating, generating a first control signal in response to the detection of operation of said one of the HVAC sub-units, wirelessly sending the first control signal to a receiver unit at the register unit, and at the register unit in response to receiving the first control signal, generating a second control signal for powering a register fan at the register unit to increase a flow rate of the forced air through the register unit.

22. Apparatus for use in increasing a flow of forced air from a HVAC unit having a heater and/or cooler sub-unit and a blower sub-unit having a blower fan for forcing heated or cooled air through a duct system to a heating/cooling zone, the apparatus comprising a register unit having a register for passing the forced air from a duct connected between the HVAC unit and the register unit, and a register fan operable to increase a flow rate of the forced air through the register, a detector at the HVAC unit for detecting when one of the HVAC sub-units is operating, a radio link having a transmitter at the HVAC unit for generating a first control signal in response to the detection of operation of said one of the HVAC sub-units, and a receiver unit at the register unit for receiving the first control signal and, in response thereto, generating a second control signal for powering the register fan.
